(19) United States
(12) Patent Application Publication
(10) Pub. No.: US 2004/0070305 A1
(43) Pub. Date: Apr. 15, 2004

(54) Stator for an automobile alternator and method

(76) Inventor: Kirk E. Neet, Saline, MI (US)

Correspondence Address: MACMILLAN, SOBANSKI & TODD, LLC, ONE MARITIME PLAZA-FOURTH FLOOR, 720 WATER STREET, TOLEDO, OH, 43604, US

(21) Appl. No.: 10/272,146

(22) Filed: Oct. 15, 2002

(51) Int. Cl. H02K 1/12

(52) U.S. Cl. 310/254

(57) ABSTRACT

A stator for a vehicle alternator, wherein the stator includes continuous coils which are wound and inserted from an inner diameter of the stator core resulting in a non-interfering front-to-back configuration.

### FIELD OF THE INVENTION

The invention relates to an alternator for an automobile and more particularly to a stator for an alternator, the stator having continuous coils which are wound and inserted from an inner diameter of the stator core and having a non-interfering front-to-back configuration.

### BACKGROUND OF THE INVENTION

Traditionally, the electrical loads of an automobile such as lighting systems, radios, windshield wipers, and horns, for example, receive electrical power from an on-board electrical power storage device such as a 12-volt (nominal) battery, for example. The 12 volt battery is charged by an alternator operating at about 14 volts, and the voltage from the alternator and/or 12 volt battery is used as a standard electrical power input for the varied types of electrical loads placed on the automobile, including continuous loads, prolonged loads, and intermittent loads. The vehicle battery and the alternator have been increasingly called upon to supply electrical power to accessories of a vehicle. For example, electrically pre-heated catalytic converters, electrically power-assisted steering, and seat and windshield heaters are now commonplace, as are other power consumers.

A stator winding is used in an automobile alternator and is produced using a wire assembled with a stator core. The conventional winding process, however, utilizes a round cross sectional wire, irregular shaped core slots, and a random type winding process, which results in a stator with a low slot fill factor and high end loop heights. These two characteristics cause the alternator to exhibit low output and efficiency. Additionally, with more and more electrical accessories being included in a vehicle, output levels, efficiency levels, compactness, and noise emissions from the alternator are of greater concern.

Recent improvements made, however, require a complicated winding process, due to the numerous welds required between individual conductors or between individual layers.

It would be desirable to produce a stator for an automobile alternator which is produced using a plurality of continuous coils per phase, and where each of the plurality of coils is wound and inserted in a slot from an inner diameter of the stator core and is arranged in a non-interfering front-to-back configuration with respect to the slot and the other coils.

### SUMMARY OF THE INVENTION

Consistent and consonant with the present invention, a stator for an automobile alternator which is produced using a plurality of continuous coils and where each of the plurality of coils is wound and inserted in a slot from an inner diameter of the stator core and is arranged in a non-interfering front-to-back configuration with respect to the slot, has surprisingly been discovered.

The stator for an automobile alternator comprises:

a generally cylindrical hollow stator core having an annular array of slots formed in an inner surface thereof, the slots extending radially outwardly from the inner surface and having a substantially constant width;

a plurality of continuous conductors having a cross section adapted to be radially inserted into the slots of the stator core, a width of each of the conductors being substantially equal to the width of each of the slots of the stator core.

### BRIEF DESCRIPTION OF THE DRAWINGS

The above, as well as other objects, features, and advantages of the present invention will be understood from the detailed description of the preferred embodiments of the present invention with reference to the accompanying drawings, in which:

FIG. 1 is an end view of a stator for an automobile alternator incorporating the features of the invention and showing phase one of a six phase, 72 slot, 3 layer stator;

FIG. 2 is an enlarged partial cross sectional view of the stator illustrated in FIG. 1 showing the stator core slot and wire cross sections contained in the slot using a rectangular continuous conductor and wherein the conductor is aligned in one radial row of each slot;

FIG. 3 is a partial cross sectional view of a stator of the prior art showing the stator core slot and wire cross sections contained in the slot using a round continuous conductor;

FIG. 4 is a partial cross sectional view of a stator of the prior art showing the stator core slot and wire cross sections contained in the slot using rectangular, u-shaped, axially inserted, and welded conductors;

FIG. 5 is a schematic view of a partial winding portion of a stator for an automobile alternator incorporating the features of the invention and showing phase 1 of a six phase, 36 slot, 3 layer stator;

FIG. 6 is a top view of the winding shown in FIG. 5; and

FIG. 7 is a schematic view of a winding prior to insertion into the stator incorporating the features of the invention and showing all six phases of a six phase, 24 slot, 2 layer stator and having the first conductor of the first phase highlighted.

FIG. 8 is a cross sectional elevational view of an alternator including a stator according to the present invention.

### DETAILED DESCRIPTION OF THE PREFERRED EMBODIMENTS

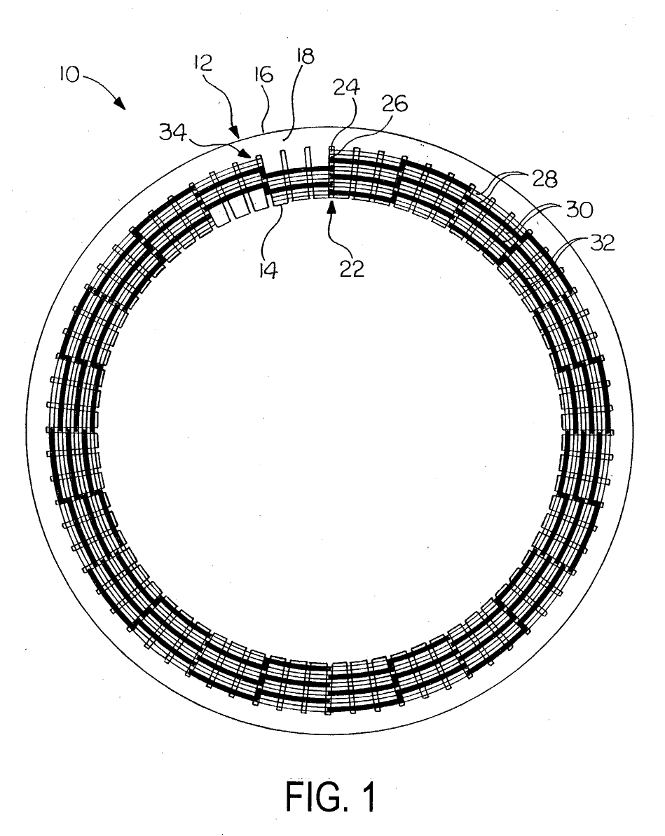

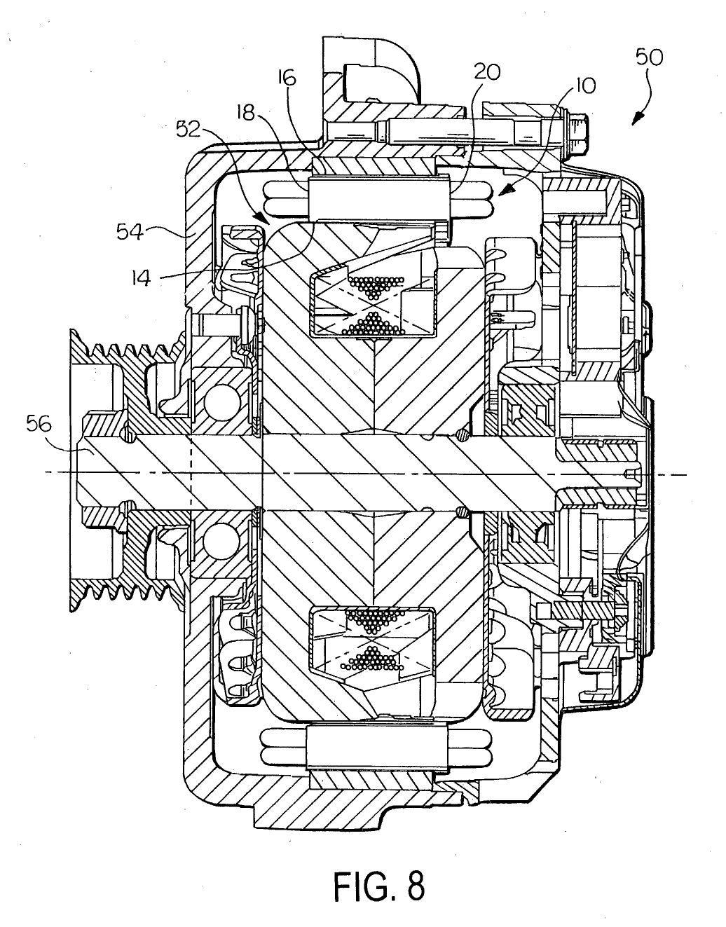

Referring now to the drawings, and particularly FIG. 1, there is shown generally at 10 a stator incorporating the features of the invention. Phase one of a six-phase stator is shown. The stator 10 includes stator core 12. The stator core 12 is an annular ring having an inner surface 14, an outer surface 16, a first side 18 and a second side 20, shown in FIG. 8. An annular array of slots 22 is formed on the inner surface 14 of the stator core 12, the slots 22 extending radially outwardly from the inner surface 14. In the embodiment shown, seventy-two slots 22 are included. It is understood that more or fewer slots could be used as desired.

A first conductor or wire 24 and a second conductor or wire 26 are alternatingly wound in the stator core 12. The first conductor 24 and the second conductor 26 cooperate to form a first phase of a six-phase conductor. Each of the first conductor 24 and the second conductor 26 are formed from a single continuous wire. As illustrated, the first conductor 24 has a lead extending perpendicularly out of the drawing figure and the second conductor 26 has a lead extending perpendicularly into the drawing figure. Three full revolutions are made by each of the first conductor 24 and the second conductor 26 to form a first layer 28, a second layer 30, and a third layer 32. In order to form the three distinct layers, a transition occurs in a transition zone 34. It is understood that more or fewer layers could be used as desired.

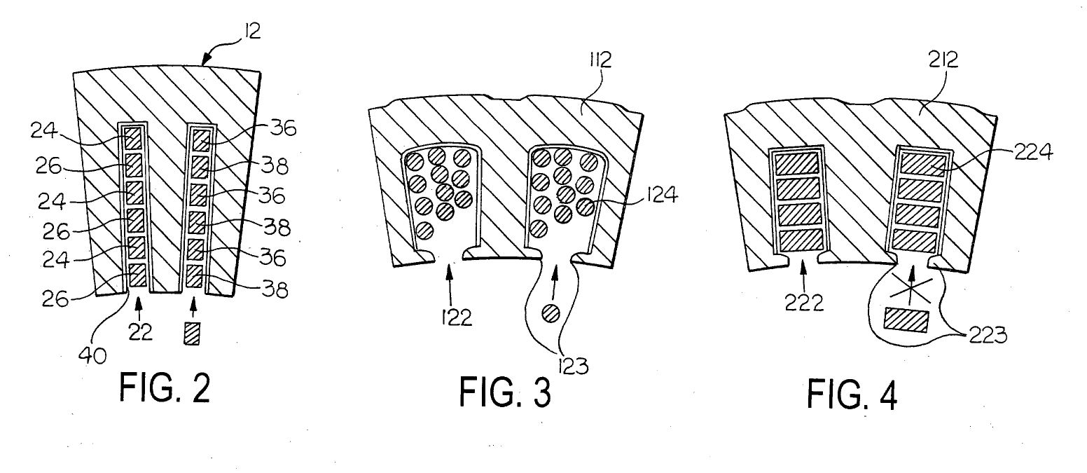

FIG. 2 is an enlarged partial cross sectional view of the stator 10 illustrated in FIG. 1 showing the stator core 12, two of the slots 22, the first conductor 24 and the second conductor 26. A third conductor 36 and a fourth conductor 38 (not shown in FIG. 1) are shown and cooperate to form a second phase of the six-phase stator. In the illustrated embodiment, the cross sectional shape of each of the first conductor 24, the second conductor 26, the third conductor 36, and the fourth conductor 38 is rectangular. It is understood that other cross sectional shapes could be used without departing from the scope and spirit of the invention. An insulating layer 40 is disposed between the conductors 24, 26, 36, 38 and the stator core 12. The slots 22 as more clearly illustrated in FIG. 2, have a generally u-shaped cross section having a main width, including any insulation (not shown), substantially equal to the width of the conductors 24, 26, 36, 38, which includes any insulation (not shown), and are adapted to receive the conductors 24, 26, 36, 38 aligned in one radial row. The slots 22 may have an opening width at the inner surface 14, which is smaller then the main width of the slots as shown in FIG. 4. In this case, the conductors 24, 26, 36, 38 may be inserted through these small slot openings, but still fit closely to the main width of the slots, by temporarily shrinking the width of the conductor or by temporarily enlarging the slot opening to accept the conductors. A depth of the slots 22 is substantially equal to the total serial depth of the number of conductors 24, 26, 36, 38, in the embodiment shown.

Referring now to FIG. 8, there is shown a cross sectional elevational view of an alternator 50 including the stator 10 according to the present invention. The stator shown is a two layer stator. The alternator 50 includes the stator 10, serving as an armature, and a rotor 52, serving as a field, contained within a housing 54. The rotor 52 integrally rotates with a shaft 56 which is rotatingly disposed within the housing 54. The general operation of an alternator is well known by one skilled in the art, as is disclosed in U.S. Pat. No. 5,998,903.

Embodiments of prior art structures are illustrated in FIGS. 3 and 4. FIG. 3 shows a stator core 112 having a plurality of slots 122 formed therein. The slots 122 have a generally u-shaped cross section with a pair of detents 123 formed on opposite sides of an inlet to the slots 122 and facing one another. A continuously wound conductor 124 having a circular cross section is radially inserted in the slots 122. The diameter of the conductor 124 is smaller than a distance between the detents 123 and does not fit closely to the sides of the slots 122.

FIG. 4 shows a stator core 212 having a plurality of slots 222 formed therein. The slots 222 have a generally u-shaped cross section with a pair of detents 223 formed on opposite sides of an inlet to the slots 222 and facing one another. A plurality of conductors 224 having a rectangular cross section are inserted axially in the slots 222 and welded to one another to form a continues winding. The width of the conductors 224 is larger than the distance between the detents 223. The conductors 224 are not continuous.

The production of the stator 10 will now be discussed. As indicated previously, the cross-section of the conductors 24, 26, 36, 38 is rectangular in shape and fits closely to the width of the slots 22. The conductors 24, 26, 36, 38 of each of the slots 22 are aligned in one radial row. Each phase of the stator 10 is comprised of only two continuous conductors, regardless of the number of desired electrical turns. The two conductors of each phase are aligned in multiple layers. In each layer, the two conductors alternate radial forward and rearward slot positions of that layer with respect to each other. Additionally, the transition zone between layers permits the two conductors to pass from one layer to the next layer but also remain in alternating radial positions with respect to each other. An end loop one of the conductors is interlaced with an end loop of the other conductors to militate against interferences.

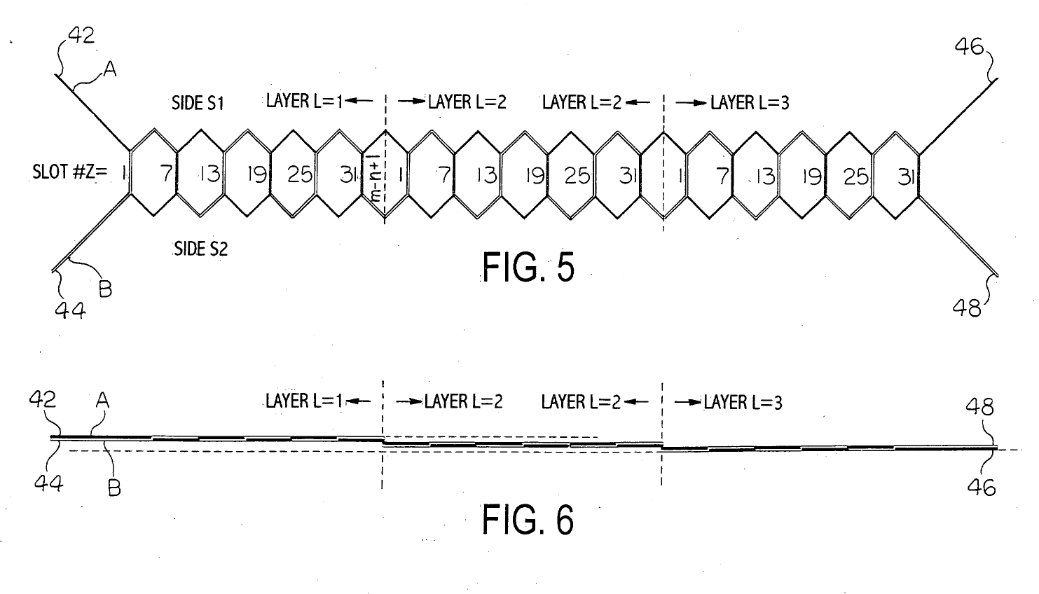

FIGS. 5-7 illustrate how the stator 10 is produced. Let:

n=the number of phases (numbered 1 through n).

m=the number of winding slots in the stator core 12 (numbered 1 through m).

z=the total number of slots 22 in the stator core 12.

S1=the first side 18 of the stator core 12.

S2=the second side 20 of the stator core 12.

L=the number of layers (a layer is defined as the portion of conductors 24, 26, 36, 38 that traverse around the stator core 12 for one revolution).

A=a first conductor of a layer.

B=a second conductor of a layer.

For simplicity, the first phase of a six phase, 36 slot, 3-layer winding is illustrated. Referring to FIG. 5, the first phase is produced by beginning with the layer L=1. In the slot z=1, a first lead 42 of the conductor A is located on the side S1 of the core in the radial rear portion of the first layer and a first lead 44 of conductor B is located on the side S2 of the core 12, in the radial front portion of the layer L=1. From the slot z=1, conductor A extends from the side S2 of the core 12 and shifts radially inward and circumferentially toward slot z=n+1 where it is located in the radial front portion of the layer L=1. Conductor B extends from the side S1 of the core 12 and shifts radially outward and circumferentially toward slot z=n+1 where it is located in the radial rear portion of the layer L=1. Conductors A and B continue around the core 12 alternating radial rear and radial front portions of the layer L=1 and extend on alternating sides of the core, until they both reach slot number z=m−n+1. This wind completes the layer L=1.

For the layer L=2, conductor A extends from the side S2 of the core 12 from slot z=m−n+1 and shifts radially inward and circumferentially toward the slot z=1, where it enters the radial rear portion of the layer L=2. Conductor B extends from the side S1 of the core 12 and shifts radially inward and circumferentially toward the slot z=1, where it enters the radial front portion of the layer L=2. Conductors A and B continue circumferentially around the core 12 similar to the layer L=1 until they both reach the slot z=m−n+1.

The layer L=3 is completed in the same manner as layer L=2.

After the layer L=3 is finished, conductor A terminates as a second lead 46 on the side S1 of the core 12 and conductor B terminates as a second lead 48 on side S2 of the core 12.

The phases 2-n are completed the same as phase n=1, except each phase is shifted over one circumferential slot z with respect to the previous phase.

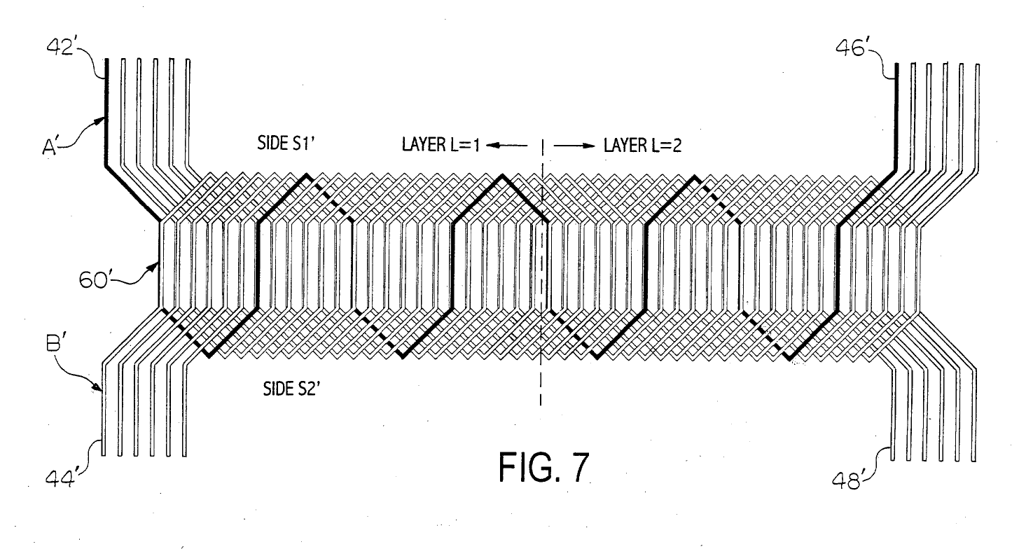

All phases of a 6 phase, 24 slot, 2 layer winding are illustrated in FIG. 7, showing the winding prior to insertion into the stator core. Conductor A′ of the first phase is highlighted for clarity.

The conductors A and B can be connected together in series to form a stator with 2L number of electrical turns, or alternatively in parallel to form a stator with L number of electrical turns. The phases of the stator 10 are connected to a rectifier (not shown) in any conventional manner such as a wye or a ring configuration, for example, to convert the generated AC current into DC current.

For the finished stator of this disclosure, conductor A′ leads 42′, 46′ are located on the side S1′ and conductor B′ leads 44′, 48′ are located on the side S2′. To connect the conductor A′ leads 42′, 46′ and conductor B′ leads 44′, 48′ to a rectifier, a first rectifier is positioned on the side S1 of the stator core, and the conductor B′ leads 44′, 48′ are routed around the outer diameter of the stator core to permit easy connection to the first rectifier.

To militate against end loop interferences, the end loops are interlaced, as schematically shown in FIG. 7. The end loop of the first phase exits one of the slots 22 and rises above the end loop of the adjacent phase at an angle. At the apex of the rise, the end loop of the first phase is jogged radially outward to allow the adjacent end loop to continue on its own apex, which is located one slot angle away from the apex of the end loop of the first phase. The end loop of the first phase lowers back towards the core behind the end loop of the adjacent phase and enters its respective one of slots 22. This is repeated around the core such that there are zero interferences between end loops of adjacent phases.

The winding of the stator 10 is assembled outside of the stator core 12. Referring again to FIG. 7 as well as FIG. 1, the conductor A′ and the conductor B′ of each phase form a plurality of straight portions 60′ having alternating end loops. The conductor A′ and the conductor B′ of all the phases, are combined outside of the stator core such that all of the end loops are interlaced as previously described and for each phase, the straight portions 60′ of the conductor A′ align and alternate forward/rearward positions with the conductor B′. The layers are aligned in a linear fashion with the second layer to the right of the first layer, the third layer to the right of the second layer, and so forth.

To insert the winding in the stator core 12, the end pair of aligned straight portions 60′ are inserted into the first of the slots 22, the next straight portion pairs are then inserted sequentially into adjacent slots 22 around the stator core 12 to the transition zone 34 to complete the first layer. At the transition zone 34, the next straight portion pairs are inserted into the first of the slots 22, lying radially inward of layer number 1. The next straight portion pairs are then inserted sequentially into adjacent slots 22 around the stator core 12 to the transition zone 34 to complete the second layer. To form a third layer as shown in FIG. 1, at the transition zone 34, the next straight portion pairs are inserted into the first of the slots 22, laying radially inward of layer number 2. The next straight portion pairs are then inserted sequentially into adjacent slots 22 around the stator core 12 to the transition zone 34 to complete the third layer. For additional layers L, the last n straight portions are the second leads of the n phases.

There are several advantages to the present invention. First, since there are two continuous conductors per phase, there are no required internal conductor connections. Second, alternator output and efficiency are improved because of the high slot fill stator design, which is the result of the rectangular shaped conductors, which fit closely to the width of the rectangular shaped slots. Slot fill is defined as the conductor cross sectional area in one slot divided by the area of that slot. Additionally, the manufacturing ease is improved, because the conductors alternate radial positions throughout the entire winding (including the transitional areas), which allows the manufacturing of the windings to be consistent and not to have require special transitional methods.

From the foregoing description, one ordinarily skilled in the art can easily ascertain the essential characteristics of this invention and, without departing from the spirit and scope thereof, can make various changes and modifications to the invention to adapt it to various usages and conditions.

What is claimed is:

1. A stator for an electric machine comprising:
a generally cylindrical hollow stator core having an annular array of slots formed in an inner surface thereof, the slots extending radially outwardly from the inner surface and having a substantially constant width; and
a plurality of continuous conductors having a cross section adapted to be radially inserted into the slots of said stator core, a width of each of said conductors being substantially equal to the width of each of the slots of said stator core.

2. The stator according to claim 1, wherein there is a plurality of pairs of conductors, said pairs of conductors cooperating to define a phase of the stator.

3. The stator according to claim 2, wherein one of the conductors of said pair of conductors alternates between a radially inward and a radially outward position with the other conductor of said pair of conductors in the slots of said stator core.

4. The stator according to claim 2, wherein said pair of conductors form a plurality of layers.

5. The stator according to claim 2, wherein said pair of conductors is arranged in series.

6. The stator according to claim 2, wherein said pair of conductors is arranged in parallel.

7. The stator according to claim 1, wherein each of said conductors has a rectangular cross section.

8. The stator according to claim 1, wherein said stator core has a first side and a second side and each of said plurality of conductors have a first end and a second end, at least one of the first ends of said plurality of conductors exiting from the slots of said stator core on the first side of said stator core and at an other of the first ends of said plurality of conductors exiting from the slots of said stator core on the second side of said stator core.

9. The stator according to claim 8, including a rectifier located the first side of the core, wherein the first ends of said plurality of conductors exiting from the second side of the core are routed axially around an outer diameter of said stator core.

10. The stator according to claim 1, wherein a plurality of end loops is formed at an end of said stator core between adjacent ones of the slots, said end loops being interlaced.

11. An alternator for an automobile comprising:
a housing;
a shaft rotatingly supported by said housing;
a rotor supported by and adapted to rotate with said shaft; and
a stator fixedly disposed in said housing adjacent said rotor, said stator comprising:
a generally cylindrical hollow stator core having an annular array of slots formed in an inner surface thereof, the slots extending radially outwardly from the inner surface and having a substantially constant width; and
a plurality of continuous conductors having a cross section adapted to be radially inserted into the slots of said stator core, a width of each of said conductors being substantially equal to the width of each of the slots of said stator core.

12. The alternator according to claim 11, wherein there is a plurality of pairs of conductors in said stator, said pairs of conductors cooperating to define a layer of conductors.

13. The alternator according to claim 12, wherein one of the conductors of said pair of conductors alternates between a radially inward and a radially outward position with the other conductor of said pair of conductors in the slots of said stator core.

14. The alternator according to claim 12, wherein said pair of conductors form a plurality of layers.

15. The alternator according to claim 12, wherein said pair of conductors is arranged in series.

16. The alternator according to claim 12, wherein said pair of conductors is arranged in parallel.

17. The alternator according to claim 11, wherein each of said conductors has a rectangular cross section.

18. A method of winding a stator for an automobile alternator, the method comprising the steps of:
a) providing a stator core having an annular array of slots formed in an inner surface thereof, the slots extending radially outwardly from the inner surface and having a substantially constant width, the stator core having a first side and a second side;
b) providing a first conductor and a second conductor representing a first phase of a winding, each of the first conductor and the second conductor having a cross section adapted to be radially inserted into the slots of the stator core, a width of each of the first conductor and the second conductor being substantially equal to the width of each of the slots of the stator core;
c) positioning the first conductor such that a first end of the first conductor lies on a first side of the winding;
d) positioning the second conductor such that a first end of the second conductor lies on a second side of the winding, the first conductor and the second conductor cooperating to form a first conductor layer;
e) bending the first conductor to form a first straight portion representing the middle of the winding;
f) bending the second conductor to be substantially parallel with and lay adjacent and on top of the first straight portion defined by the first conductor;
g) bending the second conductor to form an end loop and form a second straight portion spaced from the first straight portion in the middle of the winding;
h) bending the first conductor to form an end loop and be substantially parallel with and lay adjacent and on top of the second straight portion defined by the second conductor;
i) repeating steps e) through h) for the first conductor and the second conductor to complete a first portion of the winding that completes the first layer;
j) repeating steps e) through h) for the first conductor and the second conductor to complete a desired number of layers for the winding;
k) terminating the first conductor such that a second end of the first conductor extends from one of the first side and the second side of the winding;
l) terminating the second conductor such that a second end of the second conductor extends from the other of the first side and the second side of the winding;
m) repeating steps c) through l) for a desired number of conductors to reach a desired number of phases, shifting each phase a predetermined number of straight portions away from the first straight portion of the first phase of the winding; and
n) inserting the straight portions of the winding into the desired core slots of the stator core beginning with the first layer and ending with the last of the desired number of layers.

19. The method according to claim 15, including the step of connecting the first conductor and the second conductor in series to form a stator with a number of electrical turns equal to two times the desired number of layers of conductors.

20. The method according to claim 15, including the step of connecting the first conductor and the second conductor in parallel to form a stator with a number of electrical turns equal to one times the desired number of layers of conductors.
